(19) United States
(12) Patent Application Publication
(10) Pub. No.: US 2015/0093467 A1
(43) Pub. Date: Apr. 2, 2015

(54) FEED ROLL FOR STRAND PELLETIZERS AND METHOD FOR PRODUCING SUCH A ROLL

(71) Applicant: AUTOMATIK PLASTICS MACHINERY GMBH, Grossostheim (DE)

(72) Inventor: Jochen Scheurich, Niedernberg (DE)

(21) Appl. No.: 14/568,019

(22) Filed: Dec. 11, 2014

Related U.S. Application Data
(63) Continuation of application No. PCT/EP2013/001713, filed on Jun. 11, 2013.

(30) Foreign Application Priority Data
Jun. 12, 2012 (DE) 102012011636.5
Jun. 11, 2013 (EP) PCT/EP2013/001713

(51) Int. Cl. B29B 9/06

(52) U.S. Cl. CPC B29B 9/06; B29L 2031/772
USPC 425/308; 29/895.32; 492/49

(57) ABSTRACT

A feed roll for a strand pelletizer and a method for producing the feed roll for a strand pelletizer. The feed roll comprises a metallic roll core and a sheathing located on the metallic roll core. The sheathing can comprise a plastic material and at least one metal mesh. The feed roll can be produced by: providing a metallic roll core, arranging a metallic mesh on the roll core, and molding over the metallic mesh with a plastic material to form the sheathing.

### CROSS REFERENCE TO RELATED APPLICATIONS

The present patent application is a Continuation Application that claims priority to and the benefit of co-pending International Patent Application No. PCT/EP2013/001713, filed Jun. 11, 2013, entitled “FEED ROLL FOR STRAND PELLETIZERS AND METHOD FOR PRODUCING SUCH A ROLL”, which claims priority to DE Application No. 102012011636.5 filed Jun. 12, 2012, entitled “FEED ROLL FOR STRAND PELLETIZERS AND METHOD FOR PRODUCING SUCH A ROLL”. These references are incorporated in their entirety herein.

### FIELD

The present embodiments generally relate to a feed roll for feeding plastic strands, which are to be processed into pellets, into a strand pelletizer, and a method for producing a feed roll.

### BACKGROUND

In prior art methods for producing plastic pellets, plastic material is extruded into a plurality of strands of plastic material using a strand casting device. After the strands of plastic material have been cooled and, if applicable, subjected to strand drying, the strands of plastic material are delivered to a strand pelletizer. A feed mechanism provided in the strand pelletizer grips the strands of plastic material and conveys them to the cutting mechanism of the strand pelletizer, where they are pelletized.

The feed mechanism of such a strand pelletizer typically comprises two feed rolls arranged such that the strands of plastic material are clamped between the surfaces of the feed rolls. At least one of the two feed rolls is driven by a drive mechanism and set into rotation to draw in the strands of plastic material clamped between the feed rolls and convey them toward the cutting tool.

In the simplest case the feed rolls are made of metal, such as stainless steel, for example. Because of the high strength of the metal, feed rolls of this type have high durability and are thus relatively maintenance-free. Moreover, the metal material is a very good conductor of heat, which has the advantage that heat absorbed by the plastic strand material can be removed easily.

These feed rolls made of metal have the disadvantage that their surface has a very low coefficient of friction. The feed rolls, therefore, are often profiled for guiding the plastic strands, such as with a diamond knurling.

Alternatively, the feed rolls can exert a relatively high normal force on the plastic strands in order to achieve sufficient friction for satisfactory quality of the feed behavior. This high normal force can result in undesired deformation and flattening of the strands of plastic material in many cases. Since the metallic feed rolls are not elastic, they also are not able to adapt locally to each of the many individual strands of plastic material that are fed at the same time.

This can result in the feed roll exerting a relatively large normal force on a first strand of plastic material and consequently deforming it significantly during feeding, while a second strand of plastic material that has a slightly smaller thickness is subjected to only a small force, or indeed none at all, by the feed roll, and thus is subjected to little or even no feeding force. Consequently, this can have the undesirable result that the feeding behavior may be highly variable for the strands of plastic material.

It has likewise been known in the prior art to use feed rolls in which a sheathing comprising a polyurethane coating is applied to a core made of stainless steel or another metallic material. Polyurethane has a significantly higher coefficient of friction than metal, which has the advantage that a feed roll sheathed with polyurethane needs to exert a smaller normal force on the strands of plastic material in order to exert the same feeding force as a metal feed roll.

This has the advantage that the strands of plastic material are deformed less. Furthermore, polyurethane is an elastic material, thus allowing it to yield slightly and deform at the places where the feed roll presses on the strands of plastic material. In this way the polyurethane sheathing can adapt locally to the shape of the strands of plastic material to a certain degree. As a result, a more uniform application of force to the strands of plastic material and a more uniform feeding of the strands of plastic material can be achieved, resulting in qualitatively good and uniform feeding behavior.

However, polyurethane is not as durable as a metal, which causes feed rolls sheathed with polyurethane to wear and deform at the surface over time as well as forming grooves on the surface. This formation of grooves can impede individual strands of plastic material from being clamped and fed by the feed roll. Thus, feed rolls sheathed with polyurethane require more frequent maintenance and have shorter replacement cycles than metal feed rolls.

It is thus an object of the present invention to overcome the abovementioned disadvantages and to provide a feed roll that has a good feeding behavior and high durability, and also to specify a method for producing such a feed roll.

The present embodiments meet these needs.

### BRIEF DESCRIPTION OF THE DRAWINGS

The detailed description will be better understood in conjunction with the accompanying drawings as follows:

FIG. 1 shows one embodiment of a feed roll according to the invention.

FIG. 2 shows a second embodiment of a feed roll according to the invention.

FIG. 3 shows another embodiment of a feed roll according to the invention

FIG. 4 shows an axial view of a feed roll.

The present embodiments are detailed below with reference to the listed Figures.

### DETAILED DESCRIPTION OF THE EMBODIMENTS

Before explaining the present apparatus and method in detail, it is to be understood that the apparatus and method are not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

According to the invention, a feed roll for strand pelletizers has a metallic roll core and a sheathing located on the roll core, wherein the sheathing is made of a composite of a plastic material and at least one metal mesh.

As a result of the reinforcement with the metal mesh, the feed roll comprises a non-slip surface while at the same time retaining a high degree of elasticity. A qualitatively good feeding behavior is achieved in this way. The forces from the plastic strands that act locally on the sheathing during rolling feeding are absorbed and dissipated by the metal mesh. The metal mesh thus counteracts the displacement of the plastic material of the sheathing, and consequently helps prevent the formation of grooves, improving durability. The heat introduced by the hot plastic strands and the heat generated by the flexing work performed can be efficiently dissipated into the metallic roll core due to the increased thermal conductivity of the metal mesh. As a result, the feed roll is more temperature resistant. This further extends service life.

The plastic material can be polyurethane and contain at least one metal mesh, such as a woven stainless steel mesh.

The metal mesh can be implemented in the form of a closed circular tube. As viewed in the cross-section of the feed roll, the metal mesh can be implemented in the shape of a spiral that wraps around the roll core multiple times.

To further improve mechanical stability, and to ensure that a single part of the weave does not always lie in the region of a strand to be guided, the at least one metal mesh of the feed roll can be implemented in the shape of a helix. For example, a metal mesh implemented with a right angle pattern can be arranged in the axial direction of the feed roll at an angle thereto.

The feed roll can have a single metal mesh. Alternatively, a plurality of two, three, four, or more metal meshes can be used.

In embodiments, a topmost layer of the metal mesh is located in a region from 1 millimeter to 3 millimeters below a surface of the feed roll.

The metal mesh preferably is located in a region from 0.5 millimeters to 5 millimeters below a surface of the feed roll. In the case of a multiple wrapping of the roll core with a metal mesh and/or in the case where multiple metal meshes are used, a topmost layer or a topmost layer section of the metal mesh can be located in this region.

The roll core can be made of a stainless steel and implemented as a hollow shaft or as a hollow cylinder.

According to the invention, a method for producing a feed roll has the following steps: providing a metallic roll core, arranging at least one metallic mesh on the roll core, and molding with a plastic material to form the sheathing.

To arrange the metal mesh on the roll core, the at least one metal mesh preferably is wound onto the roll core in a spiral manner as viewed in the cross-section of the feed roll.

In embodiments, the at least one metal mesh of the feed roll can be wound onto the roll core in a helical manner, such as a metal mesh implemented with a right angle pattern, which is arranged in the axial direction of the feed roll at an angle thereto. This can further improve mechanical stability, as a single part of the weave does not always lie in the region of a strand to be guided during rotation of the feed roll.

In a strand pelletizer for processing strands of plastic material into pellets, a feed roll according to the invention can be used singly or in plurality for feeding the strands of plastic material.

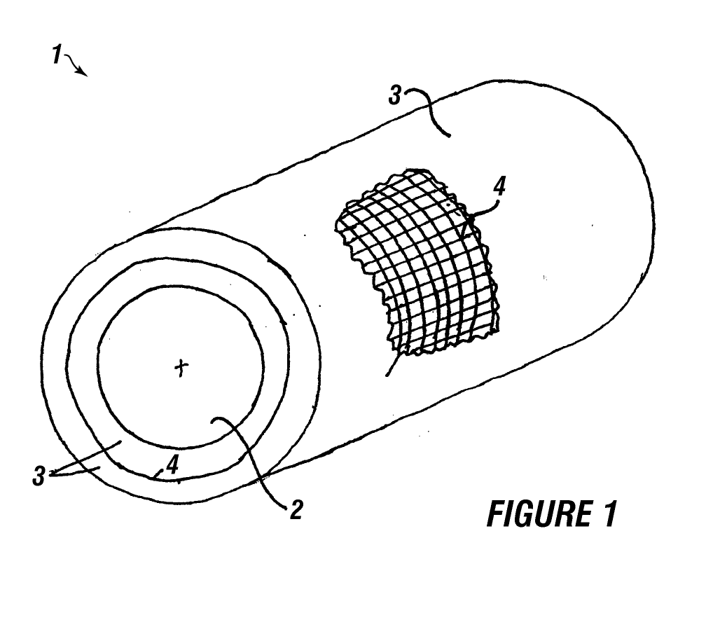

Turning now to the Figures, FIG. 1 shows one embodiment of a feed roll according to the invention.

As shown in FIG. 1, a feed roll 1 according to a first embodiment of the present invention has a metallic roll core 2 that is enclosed with a sheathing 3.

The sheathing 3 is made of a composite of a plastic material, such as polyurethane, and a metal mesh, such as a woven stainless steel mesh. The woven stainless steel mesh 4 is implemented in the form of a closed cylindrical mesh. As the schematic section 6 in the sheathing 3 shows, the woven stainless steel mesh 4 can have weft and warp wires forming the mesh that run parallel and perpendicular to the longitudinal axis of the feed roll 1.

This embodiment results in symmetrical accommodation and distribution of the forces exerted on the surface of the sheathing 3 of the feed roll 1.

The reinforcement of sheathing 3 with the woven stainless steel mesh 4 provides increased strength of the feed roll surface contacting plastic strands, while at the same time maintaining the benefit of the elasticity of the polyurethane sheathing 3.

Consequently, the sheathing can still deform locally at the places where the strands of plastic material press against the feed roll, such as by being depressed in the radial direction and thus adapting to the shape of the feed material. The forces that arise in the circumferential and longitudinal directions of the feed roll are accommodated and dissipated by the woven stainless steel mesh. Hence, these forces are efficaciously prevented from deforming the polyurethane material over time and causing groove formation.

The woven stainless steel mesh 4 can be located as close below the surface of the sheathing 3. Placement of the woven stainless steel mesh 4 directly under or very close to the surface can cause slight elevations and depressions to form on the surface of the sheathing corresponding to the weave of the woven stainless steel mesh. This can make the surface of the feed roll more non-slip and effective at gripping feed material.

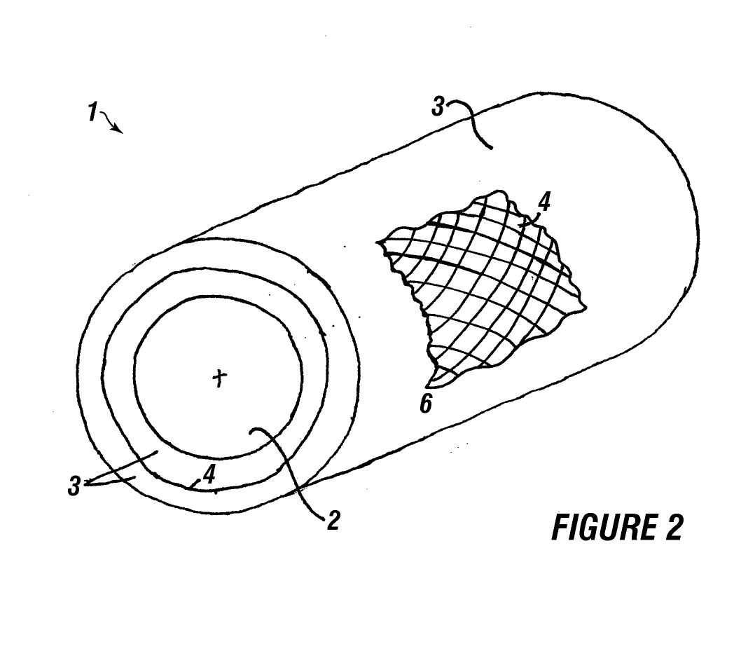

FIG. 2 shows a second embodiment of a feed roll according to the invention.

FIG. 2 shows an embodiment of the present invention wherein the woven stainless steel mesh 4 is of a right-angled design and arranged in a helical manner in contrast to the arrangement shown in FIG. 1.

In this embodiment, the weft and warp wires of the mesh can each be rotated by 45° relative to the longitudinal axis of the feed roll 1. A symmetrical force distribution can be achieved in this case, which contributes to improved heat dissipation in the axial direction of the feed roll 1.

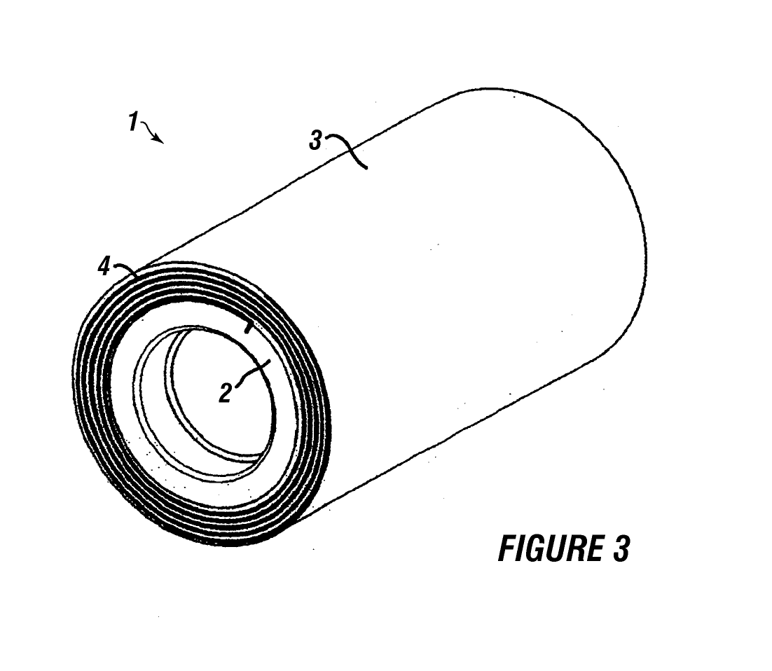

FIG. 3 shows another embodiment of a feed roll according to the invention

In this embodiment, the feed roll has a woven stainless steel mesh 4 that is wound onto the roll core 2 in a spiral manner. The woven stainless steel mesh 4 can wrap around the roll core 2 multiple times. A woven stainless steel mesh 4 analogous to the embodiment depicted in FIG. 2 forms a spiral that wraps around the roll core a plurality times. The roll core 2 can be implemented as a hollow cylinder, such as one made of stainless steel.

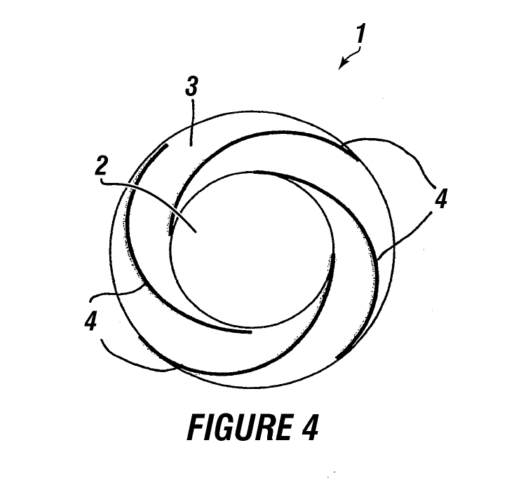

FIG. 4 shows an axial view of a feed roll.

In this embodiment, a plurality of two, three, four, or more metal meshes can be used, each of which is wound onto the roll core 2 in the shape of a spiral as viewed in cross-section. Each mesh can at least partially overlap in pairs. This embodiment illustrates how dissipation of heat into the roll core can be further improved through the use of multiple spiral-wound metal meshes.

To produce a feed roll according to the present invention, a metallic roll core 2 is first provided. At least one metal mesh 4, in particular a woven stainless steel mesh, is arranged on the roll core 2. The at least one metal mesh 4 can in particular be wound onto the roll core 2 in the shape of a spiral. Next, the arrangement of the roll core 2 and the at least one metal mesh is molded with a plastic material, in particular with polyurethane, to form the sheathing 3. The molding can be carried out using a mold provided for this purpose.

While these embodiments have been described with emphasis on the embodiments, it should be understood that within the scope of the appended claims, the embodiments might be practiced other than as specifically described herein.

What is claimed is:

1. A feed roll for a strand pelletizer having:
a. a metallic roll core; and
b. a sheathing in mechanical communication with the metallic roll core, wherein the sheathing comprises a plastic material and at least one metal mesh.

2. The feed roll of claim 1, wherein the plastic material comprises polyurethane.

3. The feed roll of claim 1, wherein the at least one metal mesh is a woven mesh.

4. The feed roll of claim 1, wherein the at least one metal mesh is implemented in the shape of a spiral as viewed in cross-section.

5. The feed roll of claim 1, wherein the at least one metal mesh is implemented in the shape of a helix.

6. The feed roll of claim 1, wherein the at least one metal mesh is wrapped around the metallic roll core a plurality of times.

7. The feed roll of claim 1, wherein the sheathing comprises a plurality of metal meshes.

8. The feed roll of claim 1, wherein the metal mesh is located in a region from 0.5 millimeters to 5 millimeters below a surface of the feed roll.

9. The feed roll of claim 1, wherein the metal mesh is located in a region from 1 millimeter to 3 millimeters below a surface of the feed roll.

10. The feed roll of claim 1, wherein a topmost layer of the metal mesh is located in a region from 0.5 millimeters to 5 millimeters below a surface of the feed roll.

11. The feed roll of claim 1, wherein a topmost layer of the metal mesh is located in a region from 1 millimeter to 3 millimeters below a surface of the feed roll.

12. The feed roll of claim 1, wherein the metallic roll core is made of a stainless steel.

13. The feed roll of claim 1, wherein the metallic roll core is a hollow cylinder.

14. A method for producing a feed roll, comprising:
a. providing a metallic roll core;
b. arranging at least one metallic mesh on the metallic roll core; and
c. molding a plastic material over the at least one metallic mesh to form a sheathing.

15. The method for producing a feed roll of claim 14, wherein the at least one metal mesh is a woven stainless steel mesh.

16. The method for producing a feed roll of claim 14, wherein the plastic material is polyurethane.

17. The method for producing a feed roll of claim 14, wherein the at least one metal mesh is wound onto the metallic roll core in a spiral manner as viewed in cross-section.

18. The method for producing a feed roll of claim 14, wherein the at least one metal mesh is wound onto the roll core in a helical manner.

19. A strand pelletizer for processing strands of plastic material into pellets, having at least one feed roll, wherein the feed roll comprises: a metallic roll core, a sheathing in mechanical communication with the metallic roll core and at least one metal mesh.
